(19) United States
(12) Patent Application Publication
(10) Pub. No.: US 2008/0126368 A1
(43) Pub. Date: May 29, 2008

(54) Document Glossaries For Linking To Resources

(75) Inventors: Vladimir Sadovsky, Bellevue, WA (US); Michael D. Stokes, Eagle, ID (US); Joseph D. Ternasky, Mountain View, CA (US); Oliver H. Foehr, Mercer Island, WA (US); Joe King, Seattle, WA (US); Marion Michael Byrd, Bellevue, WA (US); Robert L.C. Parker, Beijing (CN); Hubert Van Hoof, Seattle, WA (US); Adam C. Eversole, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/563,085

(22) Filed: Nov. 24, 2006

(51) Int. Cl. G06F 17/00

(52) U.S. Cl. 707/100

(57) ABSTRACT

An electronic document has a plurality of parts including a root relationship part, a payload part, and a glossary part. The root relationship part identifies the various parts of the electronic document. The payload part stores data for the electronic document including one or more links to relationship entries of the glossary part. The glossary part stores relationship entries, the relationship entries identifying locations of resources for the one or more links.

### BACKGROUND

As computers have become increasingly powerful and commonplace, software applications have been developed that allow documents to link to images and other files. When the document is displayed to the user, the links are used to obtain the linked-to images or other files, thereby allowing the data for such images or other files to be displayed to the user without requiring the actual content of the images or other files to be stored as part of the document. However, such linking can be problematic because the links are typically embedded in the documents side-by-side with the data for the documents. Thus, whenever any changes need to be made to a link (e.g., because the image or other file being linked to has been moved), it can be time-consuming and inefficient to search through the documents to find the links. Thus, it would be beneficial to have an improved way to manage links for documents.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with certain aspects of the document glossaries for linking to resources described herein, an electronic document has a plurality of parts including a root relationship part, a payload part, and a glossary part. The root relationship part identifies the various parts of the electronic document. The payload part stores data for the electronic document including one or more links to relationship entries of the glossary part. The glossary part stores relationship entries, the relationship entries identifying locations of resources for the one or more links.

### BRIEF DESCRIPTION OF THE DRAWINGS

The same numbers are used throughout the drawings to reference like features.

FIG. 1 illustrates an example electronic document.

FIG. 2 illustrates an example package for an electronic document.

FIG. 3 illustrates an example package for an electronic document.

FIG. 4 illustrates an example system in which the document glossaries for linking to resources discussed herein can be used.

FIG. 5 illustrates an example process for adding a link to an electronic document.

FIG. 6 illustrates an example process for integrating linked to resources into an electronic document.

FIG. 7 illustrates an example process for updating links in an electronic document.

FIG. 8 illustrates an example of a general computing device that can be used to implement the document glossaries for linking to resources discussed herein.

### DETAILED DESCRIPTION

Document glossaries for linking to resources are discussed herein. Electronic documents refer to any of a variety of different types of documents (e.g., including characters, symbols, equations, images, and so forth) that are stored electronically rather than in rendered form (e.g., rather than in paper or other hard copy form, film, bitmap image, or any other physically rendered form). Electronic documents are maintained in a package including multiple parts. The various parts are separate but related to one another. One part of the package is a glossary. Links to other resources, such as images or other files, are included in one part of the package. These links identify relationship entries in the glossary part, and the relationship entries in turn identify locations where the resources are stored. Thus, all links are consolidated into one area of the package (e.g., in a single part), and these links are all transmitted with the package when the electronic document is transmitted to some other device. Additionally, digital rights management techniques can be employed to protect the electronic document, and different rights can be assigned to different parts of the electronic document.

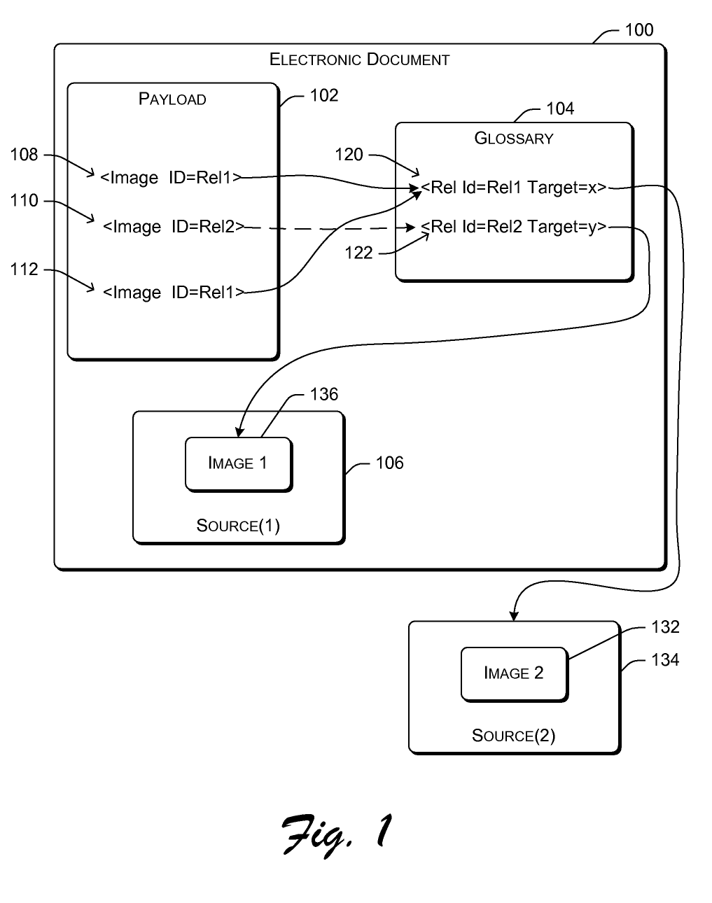

FIG. 1 illustrates an example electronic document 100. Electronic document 100 has multiple parts, including a payload part 102, a glossary part 104, and a source part 106. Payload part 102 includes most of the data of the electronic document (e.g., the words, symbols, characters, etc. of a word processing document; the data, formulas, etc., in the entries of a spreadsheet; the records of a database; the pixel values for an image; and so forth). Within payload part 102 are multiple links 108, 110, and 112, each identifying a relationship entry in glossary part 104. Typically, the links in an electronic document are included within the payload part of the electronic document, although alternatively the links may be included within different parts of the electronic document.

Each link includes an indication that it is a link, as well as a reference to a relationship entry in glossary part 104. In the example of FIG. 1, the format “<Resource ID=id>” is used for links, where Resource represents the type of resource that is linked to (and inherently indicates that the link is a link), and “ID=id” is an identifier parameter in which id represents an identifier of a relationship entry in glossary part 104. The identifier id can be any of a variety of letters, numbers, characters, symbols, and so forth that uniquely identifies the relationship entry within electronic document 100. It is to be appreciated that this is only an example format, and that other formats can be used for links. Any of a variety of different types of resources can be linked to, such as images, fonts, text files, spreadsheet files, any other type of file, and so forth.

Each link in payload part 102 identifies a relationship entry in glossary part 104, and multiple links in payload part 102 can identify the same relationship entry in glossary part 104. In the example of FIG. 1, links 108 and 112 identify relationship entry 120, and link 110 identifies relationship entry 122. The links in payload part 102 identify the relationship entries in glossary part 104 using their identifiers (e.g., “Rel1” and “Rel2” in the example of FIG. 1).

Glossary part 104 includes one or more (two are illustrated in FIG. 1) relationship entries that identify the locations of resources. The relationship entries can be maintained in glossary part 104 in accordance with any of a variety of different formats. For example, the relationship entries may be maintained in an XML format, or alternatively another proprietary or public format.

Each relationship entry in glossary part 104 includes an identifier of the relationship entry and a location where the associated resource can be found. In the example of FIG. 1, the format “<Rel ID=id Target=target>” is used for relationship entries, where “Rel” indicates that the entry is a relationship entry, “ID=id” is an identifier parameter in which id represents an identifier of the particular relationship entry, and “Target=target” is a location parameter in which target represents a location where the resource associated with the particular relationship entry can be found. The identifier id is the same identifier as is used by the links in payload part 102 to identify the relationship entry. The location of where the resource can be found can be identified in any of a variety of manners, such as a unique identifier of another part in electronic document 100, a uniform resource identifier (URI), and so forth. It is to be appreciated that this is only an example format, and that other formats can be used for relationship entries.

The location parameter of a relationship entry identifies the location where the resource associated with that relationship entry can be found. In the example of FIG. 1, relationship entry 120 has a location parameter that identifies image 132 of source 134. Source 134 is external to electronic document 100. Source 134 may be stored on the same device as electronic document 100, or alternatively may be stored on a different device (e.g., a device that is accessible over a network to which the device on which electronic document 100 is stored or being displayed is coupled). Relationship entry 122 has a location parameter that identifies image 136 of source 106. Source 106 is another part of electronic document 102.

When electronic document 100 is being displayed or otherwise presented to a user, the links 108, 110, and 112 are identified, and their corresponding relationship entries in glossary part 104 are identified. From the relationship entries, the associated resources (images in the example of FIG. 1) are accessed and displayed as part of electronic document 100.

Additional parameters can also be included in each relationship entry. One additional parameter that can be included is a target mode parameter that identifies whether the location of the associated resource is internal to electronic document 100 (e.g., is one of the multiple parts in electronic document 100) or external to electronic document 100. For example, “Targetmode=internal” can be included in a relationship entry to indicate that the associated resource is internal to electronic document 100, and “Targetmode=external” can be included in a relationship entry to indicate that the associated resource is external to electronic document 100.

An additional parameter that can be included is a type parameter that identifies a type of the resource. The type parameter may indicate, for example, that the resource is a hyperlink, is a font, is an image, is a spreadsheet file, and so forth. For example, “Type=type” can be included in a relationship entry as the type parameter, in which type represents the type of resource that is associated with the relationship entry.

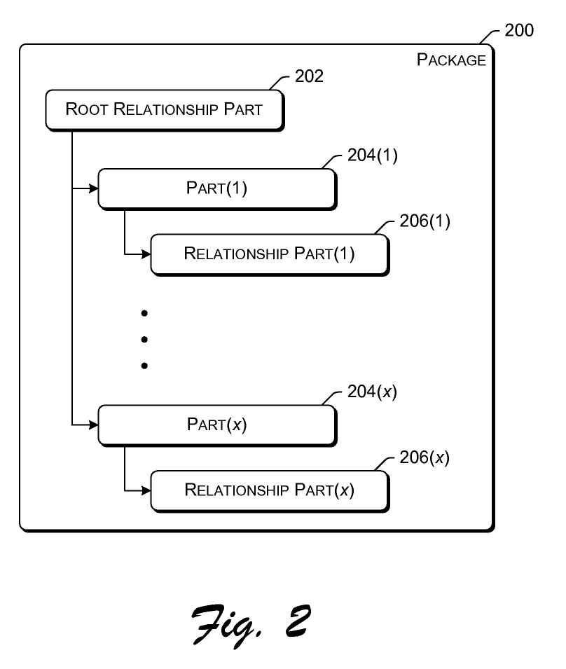

FIG. 2 illustrates an example package 200 for an electronic document, such as electronic document 100 of FIG. 1. Package 200 includes a root relationship part 202, multiple (x) parts 204(1), . . . , 204(x), and multiple (x) relationship parts 206(1), . . . , 206(x). A package refers to the logical entity that holds a collection of one or more parts, and a container refers to a file that represents a package. Typically the container is a single file, although alternatively the container may be made up of multiple files.

Each part 204 and relationship part 206, as well as root relationship part 202, can be stored in different manners. In certain embodiments, each part is a separate file, but is accessed by applications and the operating system through the package 200 rather than individually. For example, if an application desires to display an electronic document, the application does not initially access individual parts 204. Rather, the application initially accesses root relationship part 202 (and optionally one or more relationship parts 206) to identify which one or more parts 204 have the data to create the display for the electronic document, and then accesses the identified parts 204.

Root relationship part 202 identifies all the parts 204 in package 200. Each part 204 is a collection of bytes of the electronic document. Any of a variety of different formats can be used for parts 204, including public and proprietary formats. For example, some parts may be in an eXtensible Markup Language (XML) format, some may be in a HyperText Markup Language (HTML) format, others may be in a proprietary format, and so forth.

Different types of parts 204 can be included. One type of part is typically a payload part, in which most, if not all, of the data of the electronic document is stored. Other types of parts describe different aspects of the electronic document, such as digital rights management (DRM) techniques employed to protect the electronic document, tracking information for the electronic document, and so forth.

Each part 204 can have associated with it one or more relationship parts 206. Although each part 204 in FIG. 2 is illustrated as having one associated relationship part, alternatively some parts 204 may have no associated relationship parts, and some parts 204 may have two or more associated relationship parts. Each relationship part 206 identifies one or more parts 204 in package 200 or a resource external to package 200. An external resource is a resource that is not part of package 200; the resource may be located on the same computing device as package 200, or alternatively a different computing device. For example, a relationship part 206 associated with a DRM part 204 may identify the parts 204 in package 200 to which the DRM techniques in the DRM part 204 are applied. By way of another example, a relationship part 206 associated with a payload part 204 may identify an image stored at a resource external to package 200 (e.g., a location on a particular server or other computing device) that is to be included as part of the data of the electronic document (e.g., displayed to the user when the electronic document is displayed). The part 204 or external resource identified by the relationship part 206 can be identified in the relationship part 206 in different manners, such as by including in the relationship part 206 a Uniform Resource Identifier (URI) of the part 204 or external resource.

In certain embodiments, glossary part 104 of FIG. 1 is a relationship part 206 associated with a payload part 204. All of the relationship entries in glossary part 104 can be included in the same relationship part 206, or alternatively the relationship entries may be separated over multiple relationship parts 206 (e.g., each relationship entry may be a separate relationship part 206).

Typically root relationship part 202 does not directly identify all the relationship parts 206, rather root relationship part 202 relies on the parts 204 to identify their respective relationship parts 206. Alternatively, root relationship part 202 may directly identify all the relationship parts 206 as well as the parts 204.

In FIG. 2, root relationship part 202 is illustrated as identifying parts 204, and each part 204 is illustrated as identifying an associated relationship part 206. These identifications can be made in different manners. In certain embodiments, a particular naming convention is followed that allows such identifications to be made. For example, in certain embodiments the naming convention states that the relationship parts 206 are to follow the format “/_rels/*.rels”, where the “*” refers to the associated part 204. So, following this example, if a part has the name “/foo.txt”, then the associated relationship part 206 would have the name “/_rels/foo.txt.rels” or “/_rels/foo.rels”. By way of another example, in certain embodiments the naming convention states that the parts 204 are to follow the format “/*”, where the “*” refers to the part 204, so root relationship part 202 can maintain an entry in the format of “/*” for each part in package 200.

Alternatively, the parts and relationship parts 206 may be identified in different manners other than using such naming conventions. For example, root relationship part 202 may include the name (or other unique identifier) of each part 204, and each part 204 may include the name (or other unique identifier) of each associated relationship part 206.

In certain embodiments, package 200 conforms to the Open Packaging Conventions (OPC) specification. Some descriptions of OPC are included herein. Additional information regarding OPC is available as the Ecma Office Open XML File Formats Standard from Ecma International of Geneva, Switzerland (a current draft can be found on the Internet at “www” followed by “ecma-international.org/news/TC45_current_work/TC45-2006-50_final_draft.htm”). Package 200 can also conform to other proprietary or public standards, such as the XML Paper Specification (XPS). Additional information regarding XPS is available from Microsoft Corporation of Redmond, Wash.

Following OPC, each part 204 has properties including a name, a content type, and optionally a growth hint. The name property specifies the name of the part. The part names are represented by a logical hierarchy that consists of segments, with the last segment containing the actual content and the preceding segments serving to organize the parts of the package. For example, the part name “/hello/world/doc.xml” includes three segments: “hello”, “world”, and “doc.xml”. The segments “hello” and “world” serve to organize the parts of the package, and the segment “doc.xml” contains the actual content of the part.

The content type property specifies the type of content stored in the part (e.g., payload, DRM, tracking information, glossary relationship entries, etc.). The content type property defines a media type, a subtype, and an optional set of parameters. Content types conform to the definition and syntax for media types as specified in Request for Comments (RFC) 2616—Hypertext Transfer Protocol—HTTP/1.1 (e.g., section 3.7).

The growth hint property is an optional property that specifies a suggested number of bytes to reserve for the part to grow in-place. The growth hint property identifies the number of bytes by which the creator of the part predicts that the part will grow. This information may be used, for example, to reserve space in a mapping to a particular physical format in order to allow the part to grow in-place.

Following OPC, each relationship part 206 represent a relationship between a source part and a target resource (which may be another part in package 200). Relationship parts store relationships using XML. The XML of a relationship part nests one or more <Relationship> elements in a single <Relationships> element. Each <Relationship> element includes a target attribute, an id attribute, a type attribute, and optionally a target mode attribute. In a glossary part, each of these <Relationship> elements is a relationship entry.

The target attribute is a URI reference pointing to a target resource. The URI reference may be a URI or a relative reference (a reference to another part in the same package as the relationship part). The id attribute is an XML identifier that uniquely identifies the relationship part within the package that includes the relationship part. The id attribute conforms to the W3C Recommendation “XML Schema Part 2: Datatypes”.

The type attribute is a URI that uniquely defines the role of the relationship part. The type attribute allows a meaning to be associated with the relationship part. For example, the type attribute may indicate that the relationship part is a hyperlink, or points to a font, or points to an image, and so forth. The target mode attribute indicates whether the target attribute describes a resource inside the package or outside the package. For example, the value “internal” can be used to indicate that the target attribute describes a resource inside the same package as the relationship part, and the value “external” can be used to indicate that the target attribute describes a resource that is not inside the same package as the relationship part.

The container that stores the package maps the root relationship part 202, the parts 204, and the relationship parts 206 to physical package item names. The container can store the package in any of a variety of different manners, and in the OPC specification the container is a ZIP archive file. The ZIP archive file conforms to the well-known ZIP file format specification, but in certain embodiments excludes the elements of the ZIP file format specification that relate to encryption or decryption.

Each package is typically stored as a single ZIP file, although alternatively a package may be stored as multiple ZIP files, or multiple packages may be included in a single ZIP file. A ZIP file includes ZIP items, which are the root relationship part 202, the parts 204, and the relationship parts 206 of package 200.

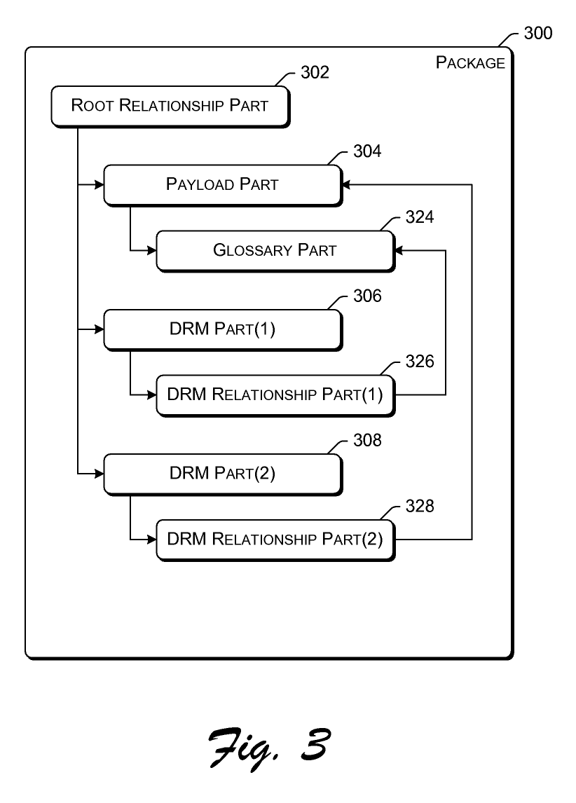

FIG. 3 illustrates an example package 300 for an electronic document. Package 300 is an example of a package 200 of FIG. 2. Package 300 includes a root relationship part 302, parts 304, 306, and 308, and relationship parts 324, 326, and 328.

Payload part 304 contains most of the data for the electronic document (e.g., a word processing document), and glossary part 324 is a relationship part that identifies one or more external resources (not shown) that are to be presented as part of the electronic document (e.g., one or more images). DRM part 306 includes the digital rights management for different parts of package 300 as identified by DRM relationship part 326. In the illustrated example, the rights described by DRM part 306 are applied to glossary part 324. The information maintained in DRM part 306 can vary based on the type of digital rights management being used and the results desired by the creator of DRM part 306 (and/or by others with access to modify DRM part 306). DRM part 306 can identify, for example, the user identifiers of others that are permitted to access part 324, a digital certificate that is required by a device or application in order to access and/or modify part 324, and so forth.

DRM signature part 308 includes a digital signature for different parts of package 300 as identified by DRM signature relationship part 328. In the illustrated example, the digital signature in part 308 is applied to payload part 304. Analogous to DRM part 306, the information maintained in DRM part 308 can vary based on the type of digital rights management being used and the results desired by the creator of DRM part 308 (and/or by others with access to modify DRM part 308). DRM part 308 can identify, for example, the user identifiers of others that are permitted to access part 304, a digital certificate that is required by a device or application in order to access and/or modify part 304, and so forth

The DRM can be used with package 300 in a variety of different manners. For example, the DRM can apply to payload part 304 but not to glossary part 324. In such a situation, the DRM restricts access to and/or modification of payload part 304 but does not restrict access to and/or modification of glossary part 324. Thus, the relationship entries in glossary part 324 can be updated if the locations of the resources are changed so that the links in payload part 304 are correct even though the program or device performing the change may not have access to modify payload part 304. By way of another example, different rights can apply to glossary part 324 than apply to payload part 304. In such a situation, the DRM can restrict access to and/or modification of payload part 304 in a different manner than access to and/or modification of glossary part 324 is restricted.

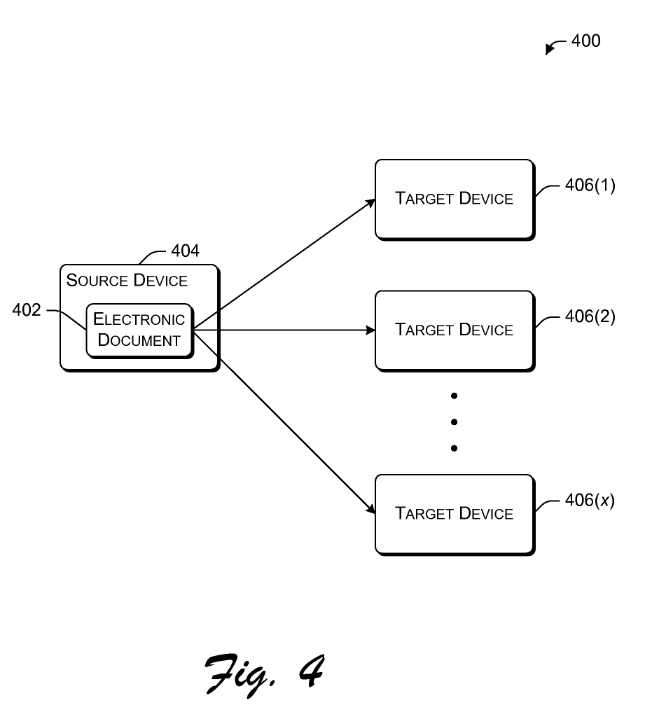

FIG. 4 illustrates an example system 400 in which the document glossaries for linking to resources discussed herein can be used. An electronic document 402 is maintained on a source device 404. Source device 404 may be the device on which electronic document 402 was created, or alternatively may be a device to which electronic document 402 was transmitted. Electronic document 402 can be, for example, electronic document 100 of FIG. 1. Electronic document 402 contains a glossary part and links to relationship entries in the glossary part as discussed above.

Electronic document 100 can be transmitted to one or more of multiple (x) target devices 406(1), 406(2), . . . , 406(x). Target devices 406 can be any of a variety of different types of devices, such as computers (e.g., handheld computers, desktop computers, laptop computers, server computers, and so forth), printers, storage devices, and so forth. Electronic document 100 is transmitted as a package as discussed above (e.g., package 200 of FIG. 2 or package 300 of FIG. 3). The glossary part and the links to relationship entries in the glossary part are maintained as is when electronic document 100 is transmitted to any of target devices 406.

Each target device 406 can itself transmit the package to other target devices. Additionally, each target device 406 can present or otherwise consume the electronic document by accessing the glossary part and retrieving the resources identified in the glossary part. Consuming an electronic document refers to processing the electronic document to make it ready for presentation to, or presenting it to, a user(s). For example, a device may consume the electronic document by displaying it on a monitor. By way of another example, a device may consume the electronic document by generating a bitmap image of what the electronic document is to be displayed as. By way of yet another example, a device may consume the electronic document by printing the electronic document on paper.

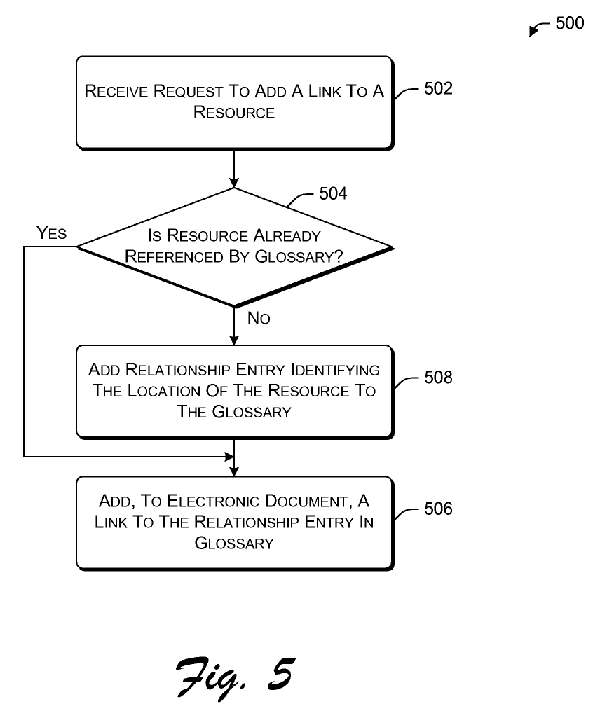

FIG. 5 illustrates an example process 500 for adding a link to an electronic document. Process 500 can be carried out, for example, by an operating system or application program in creating or modifying an electronic document, and may be implemented in software, firmware, hardware, or combinations thereof.

Initially, a request to add a link to a resource is received (act 502). This request is a request to add the link to an electronic document. This request can be made in any of a variety of manners, and typically is made by a user selecting an option to insert a link, such as from a pull-down menu or some other user interface mechanism. As part of the user selection process, the user typically identifies the particular resource (such as an image, font, file, etc.), by its location, that he or she desires to have linked into the electronic document.

A check is then made as to whether the resource is already referenced by the glossary of the electronic document (act 504). If the resource is already referenced by the glossary, then the glossary will have a relationship entry that identifies that resource. The relationship entries can be searched to identify an entry that is associated with that resource. For example, the request received in act 502 typically includes an indication of the resource to be linked to and where that resource is located. The relationship entries in the glossary can be searched, and if a location in one of the relationship entries matches (is the same as) the location that is received in act 502, then the resource is already referenced by the glossary.

If the resource is already referenced by the glossary, then a link to the relationship entry in the glossary that is associated with the resource is added to the electronic document (act 506). No additional relationship entry need be added to the glossary because a relationship entry associated with the resource is already in the glossary.

However, if the resource is not already referenced by the glossary, then a relationship entry identifying the location of the resource is added to the glossary (act 508). A link to this newly added relationship entry in the glossary is also added to the electronic document (act 506).

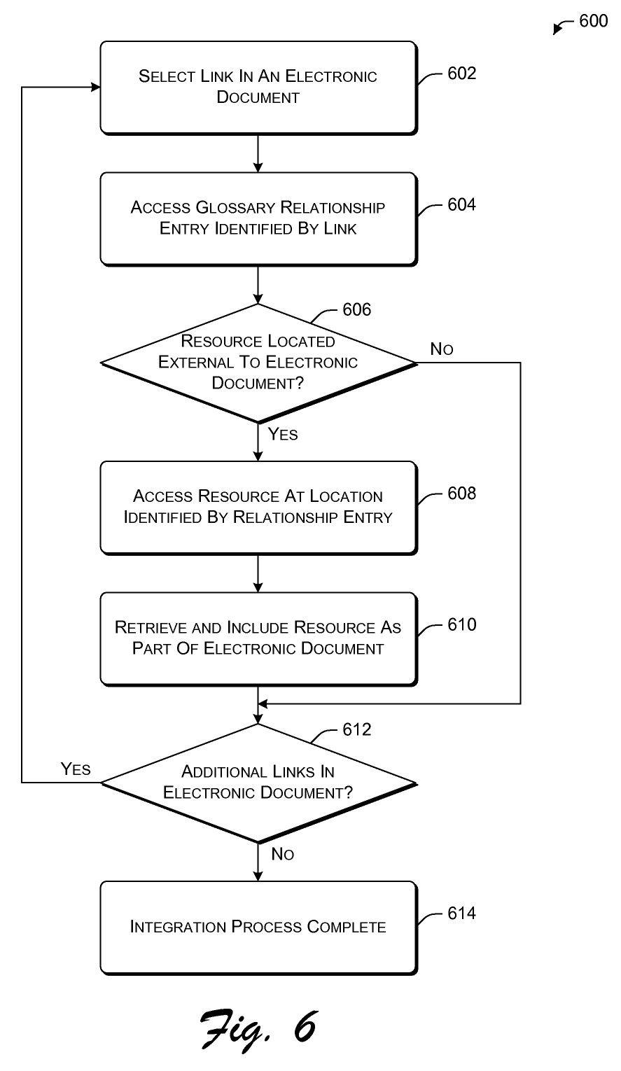

FIG. 6 illustrates an example process 600 for integrating linked to resources into an electronic document. Process 600 can be carried out, for example, by an operating system or application program presenting or otherwise consuming an electronic document, and may be implemented in software, firmware, hardware, or combinations thereof.

Initially, a link in an electronic document is selected (act 602). The manner in which the link is identified and selected can vary depending on the manner in which links are stored in the electronic document. The application or other component performing process 600 knows, or knows how to determine, the manner in which links are stored in the electronic document and thus knows how to identify links in the electronic document. The links in the electronic document can be selected in different manners, such as by type, randomly, in order of occurrence in the electronic document, and so forth.

The glossary relationship entry identified by the link from act 602 is then accessed (act 604), and a check is made as to whether the resource is located external to the electronic document (act 606). If the resource is located external to the electronic document, then the resource at the location identified by that relationship entry is accessed (act 608). The resource at that location is then retrieved and included as part of the electronic document (act 610). The manner in which the resource is included as part of the electronic document can vary based on the application that is using the electronic document. For example, the content of the linked to resource can be presented as if it were part of the electronic document.

The inclusion of the resource as part of the electronic document can take different forms. For example, a copy of the resource may temporarily be made a part of the electronic document, and the relationship entry may temporarily be updated to reflect this temporarily created part of the electronic document. When presentation of the electronic document is complete (e.g., the document has been printed, the application that is presenting the document closes the document, and so forth), these temporarily created parts and relationship entries are deleted. By way of another example, a copy of the resource may be made on the same device as is presenting the electronic document. This copy can be temporary or permanent, and the relationship entry can then be updated to identify this new copy of the resource. Following this example, the resource remains external to the electronic document, but is still maintained locally at the same device as the electronic document, allowing the electronic document to typically be presented more quickly than when the resource is on another device.

A check is then made as to whether there are any additional links in the electronic document that have not yet been selected (act 612). If there are additional links, then one of those is selected (act 602). However, if there are no additional links, then the integration process is complete (act 614).

Returning to act 606, if the resource is not located external to the electronic document, then process 600 proceeds to check whether there are any additional links in the electronic document that have not yet been selected (act 612). If the resource is not located external to the electronic document, then the resource is already included as part of the electronic document and thus need not be retrieved.

Process 600 is discussed above as repeating acts 602-612 until all links in the electronic document have been selected. Alternatively, acts 602-612 may be repeated only until certain links have been selected. For example, an electronic document may be consumed as multiple pages, and different ones of those pages may include resources that are linked to. In this example, acts 602-612 can be repeated for the links on the pages as the pages are consumed, so that if a particular page has not been consumed then acts 602-612 need not be repeated for the link(s) on that page. Additionally, it should be noted that in such situations, even though all of the pages may not yet be consumed, different parts of the electronic document (e.g., the glossary part) would be retrieved and available in their entirety.

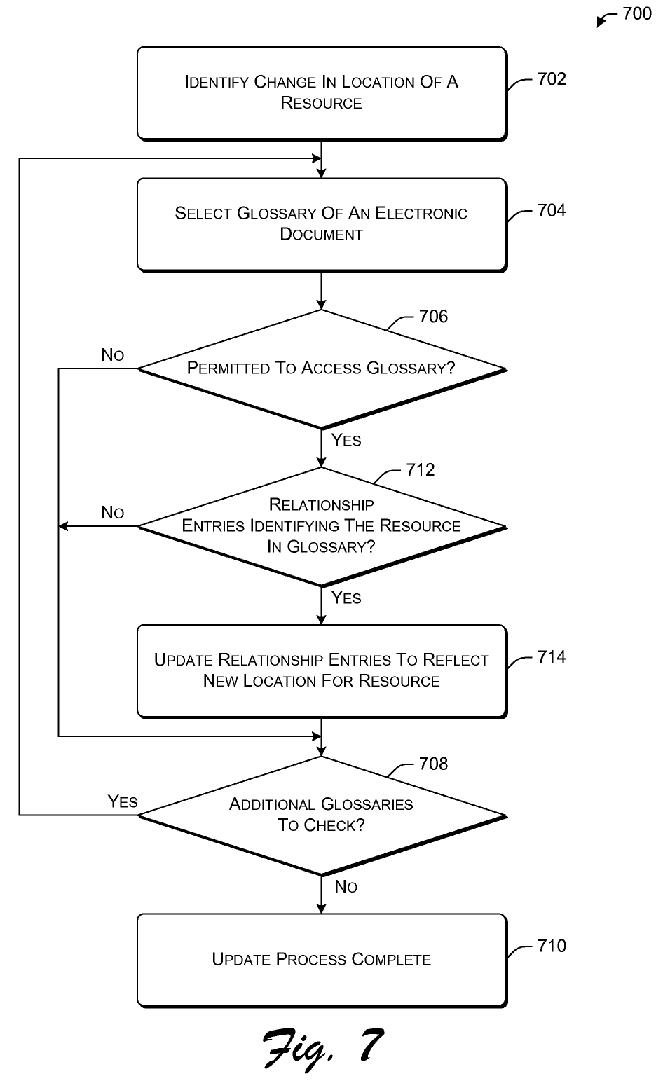

FIG. 7 illustrates an example process 700 for updating links in an electronic document. Process 700 can be carried out, for example, by an operating system or application program presenting or otherwise consuming an electronic document, and may be implemented in software, firmware, hardware, or combinations thereof.

Initially, a change in a location of a resource is identified (act 702). Such changes are typically identified to the program or component performing process 700, such as by a system administrator that is aware of the location change. A glossary of an electronic document is selected (act 704), and a determination is made as to whether the program or component performing process 700 is permitted to access the glossary (act 706). This access in act 706 typically includes permission to read and/or modify the glossary. This determination is made, for example, based on the DRM information in the electronic document.

If access to the glossary is not permitted, then a check is made as to whether there are additional glossaries to check (act 708). As a change in the location of a resource can affect multiple electronic documents, there may be multiple glossaries to check. The glossaries to check can be determined in different manners, such as all electronic documents stored on a particular device or in a particular part of a particular device, all electronic documents accessible to a particular device, and so on.

If there are additional glossaries to check, then process 700 returns to act 704 to select one of those glossaries. However, if there are no additional glossaries to check, then the updating process 700 is complete (act 710).

Returning to act 706, if access to the glossary is permitted, then a check is made as to whether there are any entries in the glossary identifying the resource (act 712). This check can be performed, for example, by comparing the resource locations identified in each relationship entry with the old location of the resource (the location of the resource before it was changed). If there are no relationship entries identifying the resource in the glossary, then process 700 proceeds to check whether there are additional glossaries to check (act 708). However, if there are relationship entries identifying the resource in the glossary then those relationships are updated to reflect the new location of the resource (act 714). This updating includes changing the relationship entry to include the new location of the resource rather than the previous location of the resource. Process 700 then proceeds to check whether there are additional glossaries to check (act 708).

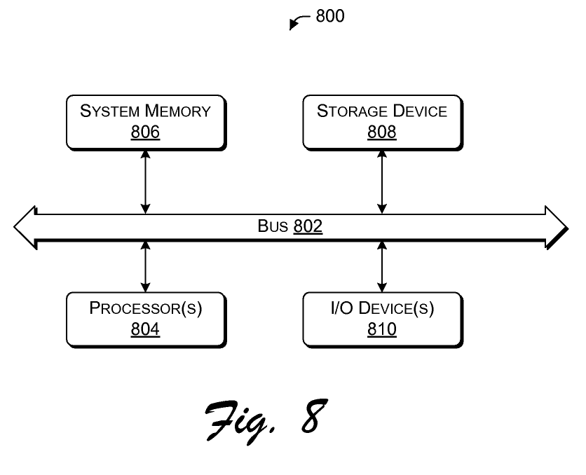

FIG. 8 illustrates an example of a general computing device 800 that can be used to implement the document glossaries for linking to resources discussed herein. Computing device 800 can be a device the uses electronic document 100 of FIG. 1, and that implements process 500 of FIG. 5, process 600 of FIG. 6, and/or process 700 of FIG. 7. Computing device 800 is only one example of a computing device and is not intended to suggest any limitation as to the scope of use or functionality of the computing device and network architectures. Neither should computing device 800 be interpreted as having any requirement regarding the inclusion (or exclusion) of any components or the coupling or combination of components illustrated in the example computing device 800.

Computing device 800 is a general-purpose computing device that can include, but is not limited to, one or more processors or processing units 804, a system memory 806, and a bus 802 that couples various system components including the processor 804 to the system memory 806.

Bus 802 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

System memory 806 includes computer readable media in the form of volatile memory, such as random access memory (RAM), and/or non-volatile memory, such as read only memory (ROM).

Computing device 800 may also include other removable/non-removable, volatile/non-volatile computer storage device 808. By way of example, storage device 808 may be one or more of a hard disk drive for reading from and writing to a non-removable, non-volatile magnetic media, a magnetic disk drive for reading from and writing to a removable, non-volatile magnetic disk (e.g., a “floppy disk”), an optical disk drive for reading from and/or writing to a removable, non-volatile optical disk such as a CD, DVD, or other optical media, a flash memory device, and so forth. These storage device(s) and their associated computer-readable media provide storage of computer readable instructions, data structures, program modules, and/or other data for computing device 800.

User commands and other information can be entered into computing device 800 via one or more input/output (I/O) devices 810, such as a keyboard, a pointing device (e.g., a “mouse”), a microphone, a joystick, a game pad, a satellite dish, a serial port, a universal serial bus (USB), an IEEE 1394 bus, a scanner, a network interface or adapter, a modem, and so forth. Information and data can also be output by computing device 800 via one or more I/O devices 810, such as a monitor, a printer, a network interface or adapter, a modem, a speaker, and so forth.

An implementation of the document glossaries for linking to resources described herein may be described in the general context of processor-executable instructions or computer-executable instructions, such as program modules, executed by one or more computing devices. Generally, program modules include routines, programs, objects, components, data structures, etc. that perform particular tasks or implement particular abstract data types. Typically, the functionality of the program modules may be combined or distributed as desired in various embodiments.

An implementation of the document glossaries for linking to resources may be stored on or transmitted across some form of computer readable media. Computer readable media or processor-readable media can be any available media that can be accessed by a computer. By way of example, and not limitation, computer readable media or processor readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Alternatively, all or portions of these modules and techniques may be implemented in hardware or a combination of hardware, software, and/or firmware. For example, one or more application specific integrated circuits (ASICs) or programmable logic devices (PLDs) could be designed or programmed to implement one or more portions of the framework.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer readable media having stored thereon a plurality of instructions that, when executed by one or more processors, causes the one or more processors to:
generate a plurality of parts for an electronic document, the plurality of parts including:
a root relationship part that identifies one or more of the plurality of parts,
a glossary part identified by the root relationship part, and
a payload part, identified by the root relationship part, that stores data for the electronic document including one or more links to relationship entries of the glossary part,
the glossary part storing the relationship entries, the relationship entries identifying locations of resources for the one or more links; and
store the plurality of parts in a single package.

2. One or more computer readable media as recited in claim 1, the one or more processors being part of a computing device, and the plurality of instructions further causing the one or more processors to transmit the single package to one or more target devices.

3. One or more computer readable media as recited in claim 1, wherein one or more of the relationship entries identifies a location that is one of the plurality of parts.

4. One or more computer readable media as recited in claim 1, the one or more processors being part of a computing device, and wherein one or more of the relationship entries identifies a location that is on another computing device.

5. One or more computer readable media as recited in claim 1, wherein each of the relationship entries includes an identifier of the relationship entry and a location where a resource associated with the relationship entry can be found.

6. One or more computer readable media as recited in claim 5, wherein each of the relationship entries further includes an indication of whether the location of the resource associated with the relationship entry is one of the plurality of parts, and an indication of a type of the resource.

7. One or more computer readable media as recited in claim 1, the plurality of instructions further causing the one or more processors to:
receive a request to add, to the payload part, a link to a first resource;
check whether the first resource is already referenced by a relationship entry of the glossary part;
if the first resource is already referenced by a relationship entry of the glossary part, then add, to the payload part, a link to the relationship entry of the glossary part that references the first resource; and
if the first resource is not already referenced by the a relationship entry of the glossary part, then:
add, to the glossary part, a new relationship entry that identifies a location of the first resource; and
add, to the payload part, a link to the new relationship entry.

8. One or more computer readable media as recited in claim 1, the plurality of instructions further causing the one or more processors to:
identify one of the one or more links in the payload part;
access a relationship entry of the glossary identified by the one link;
access a resource at a location identified by the accessed relationship entry; and
include the resource as part of the electronic document.

9. One or more computer readable media as recited in claim 1, the plurality of instructions further causing the one or more processors to:
identify a change in a location of a resource to a new location;
check whether any of the relationship entries of the glossary part identify the resource; and
for each relationship entry of the glossary part that identifies the resource, update the relationship entry to reflect the new location.

10. One or more computer readable media as recited in claim 9, the plurality of instructions further causing the one or more processors to:
update the relationship entry to reflect the new location only if a digital rights management part of the plurality of parts indicates that the plurality of instructions are permitted to modify the relationship entry.

11. A method comprising:
receiving a request to add, to an electronic document, a link to a resource;
checking whether the resource is already referenced by the glossary;
if the resource is already referenced by the glossary, then adding, to the electronic document, a link to a relationship entry of the glossary that references the resource; and
if the resource is not already referenced by the glossary, then:
adding, to the glossary, a new relationship entry that identifies a location of the resource; and
adding, to the electronic document, a link to the new relationship entry.

12. A method as recited in claim 11, wherein the resource is located external to the electronic document.

13. A method as recited in claim 12, wherein the method is implemented on a computing device, and wherein the resource is located on another computing device.

14. A method as recited in claim 11, wherein the new relationship entry includes an identifier of the new relationship entry and an identification of the location of the resource.

15. A method as recited in claim 14, wherein the new relationship entry further includes an indication of whether the location of the resource is internal to the electronic document, and an indication of a type of the resource.

16. One or more computer readable media having stored thereon a plurality of instructions that, when executed by one or more processors, causes the one or more processors to:
identify a link in an electronic document;
access a glossary relationship entry identified by the link;
access a resource at a location identified by the relationship entry; and
include the resource as part of the electronic document.

17. One or more computer readable media as recited in claim 16, wherein the location is external to the electronic document.

18. One or more computer readable media as recited in claim 17, the one or more processors being part of a computing device, and wherein the location is on another computing device.

19. One or more computer readable media as recited in claim 16, wherein the relationship entry includes an identifier of the relationship entry and an identification of the location of the resource.

20. One or more computer readable media as recited in claim 19, wherein the relationship entry further includes an indication of whether the location of the resource is internal to the electronic document, and an indication of a type of the resource.
